(19) United States
(12) Patent Application Publication
(10) Pub. No.: US 2021/0138284 A1
(43) Pub. Date: May 13, 2021

(54) Fire Suppression Apparatus, System, and Method

(71) Applicant: Martin George Bruce, Arlington, TX (US)

(72) Inventor: Martin George Bruce, Arlington, TX (US)

(21) Appl. No.: 17/091,717

(22) Filed: Nov. 6, 2020

Related U.S. Application Data
(60) Provisional application No. 62/931,901, filed on Nov. 7, 2019.

(51) Int. Cl. A62C 35/68; A62C 35/02; A62C 3/02

(52) U.S. Cl. CPC A62C 35/68; A62C 11/005; A62C 3/0292; A62C 35/02

(57) ABSTRACT

A fire suppression system includes a pipe having one or more dispersion features, a valve assembly coupled to the pipe, and a fire extinguisher unit coupled to the pipe via the valve assembly. The fire extinguisher unit includes a tank containing a fire suppressing agent. The valve assembly includes a connector with a first part attached to the fire extinguisher unit and a second part attached to the pipe. The valve assembly permits the fire extinguisher unit to be connected to the pipe of the fire suppression system to share the fire suppressing agent with the pipe and the one or more dispersion features to suppress fire or to be disconnected from the pipe for manual use to suppress fire.

### RELATED APPLICATION DATA

This patent is entitled to the benefit of and claims priority to co-pending U.S. Provisional Application Ser. No. 62/931,901 filed Nov. 7, 2019 and entitled “Valve connect/disconnect system for fire extinguisher/suppression system.” The entire content of this prior filed application is hereby incorporated herein by reference.

### BACKGROUND

### 1. Field of the Disclosure

The present disclosure is generally directed to fire suppression, and more particularly to a fire suppression apparatus, system, and method utilizing one or more fire extinguishers that can connect to and disconnect from the system for multiple uses.

### 2. Description of Related Art

Fire suppression systems are known in the art. Such systems are typically installed and used within a wide variety of environments. Just some of many possible examples include buildings; kitchens; control rooms; computer rooms; manufacturing plant machines; CNC machines; wind turbines; paper plants; transportation, such as cars, buses, airplanes, helicopters, campers, recreational vehicles, terminals, and the like; ground equipment; mining; hospitals; document rooms; military equipment and facilities; and the like. These known fire suppression systems all have a common feature in that they are permanently installed and joined together as one unit. These known systems are fixed in place unless activated and discarded or decommissioned and no longer required. These existing fire suppression systems are connected to a source or a container holding a fire suppression agent, such as water. Such permanent installed systems are controlled by manual activation or by automatic activation to release the agent in order to suppress a fire

It is also well known to provide and use standalone manually operated fire extinguishers to suppress fires. Such fire extinguishers or units may be wall mounted, free standing, or housed within an enclosure. The fire extinguishers or units are operated manually by a user to release a fire suppressing agent from the unit and to direct the agent toward a fire to suppress the fire. Fire extinguishing units contain a fire suppressing agent within a container of the unit. The agent may be water, solid or liquid chemicals, a gas, or a mixture of one or more agent type.

One problem with these types of suppression systems or fire extinguisher units is that they are limited to a single type of use. The typical installed suppression system is connected to a store of suppression agent and permanently installed and fixed in place. Such a system releases the agent from fixed points along the system. The typical fire extinguisher unit is only for manual use. The two types of systems or suppression methods are redundant to one or other. One problem with stand-alone fire extinguishers is that they are not reactive or automatic, but instead only manually operated by a user upon detecting a fire. These problems can cause various restrictions when fighting fires and in choosing the correct equipment to do so.

### SUMMARY

In one example according to the teachings of the present disclosure, a fire suppression system includes a pipe having one or more dispersion features, a valve assembly coupled to the pipe, and a fire extinguisher unit coupled to the pipe via the valve assembly. The fire extinguisher unit includes a tank containing a fire suppressing agent. The valve assembly includes a connector with a first part attached to the fire extinguisher unit and a second part attached to the pipe. The valve assembly is configured to permit the fire extinguisher unit to be connected to the pipe of the fire suppression system to share the fire suppressing agent with the pipe and the one or more dispersion features to suppress fire or to be disconnected from the pipe for manual use to suppress fire.

In one example, the valve assembly can be configured to contain any fluid or pressure loss in the fire extinguisher unit and the pipe when the first part and second part of the valve assembly are disconnected when the fire extinguisher unit is disconnected from the pipe.

In one example, the valve assembly can be corrosion resistant.

In one example, when activated, the fire extinguisher unit can be configured so that the fire suppressing agent can exit the tank and can be dispersed from the one or more dispersion features of the pipe to suppress fire.

In one example, the fire suppression system can include two or more of the fire extinguisher units and respective valve assemblies. Each of the two or more fire extinguisher units can be releasable under pressure from the pipe and usable manually to suppress a fire.

In one example, a one-way valve can be provided at least one the first part of the connector. The one-way valve can be closed to isolate the fire extinguisher unit for use in manually suppressing fire when the connector is disconnected to release the fire extinguisher unit.

In one example, the fire suppression system can include a coupling associated with the connector of the valve assembly. The coupling can be actuatable to release the fire extinguisher unit from the pipe.

In one example, a one-way valve can be provided on each of the first part and the second part of the connector. Each one-way valve can be closed and isolated from the other when a coupling of the connector is actuated to release the fire extinguisher unit.

In one example, the first part and the second part of the connector of the valve assembly can be connected to each other with a set of one-way valves.

In one example, the valve assembly can be made substantially from a stainless-steel material or a carbon steel material.

In one example, the one or more dispersion features can be nozzles attached to the pipe.

In one example, the pipe can be configured to locally burst when subjected to a fire. Each burst in the pipe can define one of the one or more dispersion features.

In one example according to the teachings of the present disclosure, an apparatus for a fire suppression system includes a fire extinguisher unit with a tank containing a fire suppressing agent, a manual valve assembly, and a hose in fluid communication with the tank via the manual valve and operable for dispersing the fire suppressing agent. The apparatus also includes a valve assembly coupled to the tank. The valve assembly has a connector with a first part attached to the fire extinguisher unit and a second part attached to a valve body configured to be attached to a pipe of a fire suppression system. The valve assembly is configured to permit the first part and the second part of the connector to be connected in order to share the fire suppressing agent with the pipe and the fire suppression system and to permit the first part to be disconnected from the second part of the connector in order to permit manual use of the fire extinguisher unit to suppress fire.

In one example according to the teachings of the present disclosure, a fire suppression system includes a pipe with one or more dispersion features, a valve assembly coupled to the pipe, and a fire extinguisher unit coupled to the pipe via the valve assembly. The valve assembly is configured to permit the fire extinguisher unit to be connected to the pipe to share the fire suppressing agent with the pipe and the one or more dispersion features to suppress fire and to permit the fire extinguisher unit to be disconnected from the pipe for manual use to suppress fire.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention will become apparent upon reading the following description in conjunction with the drawing figures, in which:

FIG. 1 shows a simplified schematic of one example of an existing or prior art fire suppression system.

FIG. 2 shows a simplified schematic of a fire suppression system according to the teachings of the present disclosure.

FIG. 3 shows a close up view of a portion of a fire extinguisher unit of the fire suppression system of FIG. 2, and with the fire extinguisher unit connected to the system.

FIG. 4 shows the portion of the fire extinguisher unit of FIG. 3 but disconnected from the system.

FIG. 5 shows an alternate example of a fire extinguisher unit for a fire suppression system according to the teachings of the present disclosure.

FIG. 6 shows a simplified schematic of another example of a fire suppression system according to the teachings of the present disclosure

FIG. 7 shows a flow chart of one example of a fire suppression method using the disclosed fire suppression system according to the teachings of the present disclosure.

The use of the same reference numbers or characters throughout the description and drawings indicates similar or identical components, aspects, and features of the disclosure.

### DETAILED DESCRIPTION OF THE DISCLOSURE

It is broadly an object of the present disclosure to address one or more of the above mentioned problems and/or disadvantages with prior known fire suppression apparatuses, systems, and methods. The disclosed apparatus, system, and method may improve upon or minimize at least some of the above-mentioned problems and/or disadvantages.

According to a first aspect of the disclosure, a fire suppression system includes a pipe or tube, a valve arrangement with one or more valve assemblies, and a corresponding one or more fire extinguisher units coupled to the pipe or tube via the one or more valve assemblies. Each valve assembly includes a male/female connector. Each male/female connector has a first part attached to the respective fire extinguisher unit and a second part attached to the pipe or tube. Each valve assembly is configured to permit the respective fire extinguisher unit to be connected to the pipe or tube of the fire suppression system and to be disconnected from the pipe assembly. The fire suppression system may optionally remain operational whether a fire extinguisher unit is disconnected from the system. The fire extinguisher unit is manually operable as a typical fire extinguisher when disconnected from the fire suppression system.

According to another aspect of the disclosure, each fire extinguisher unit may be connected or disconnected with zero pressure or may be connected pressurized in order to meet with the required contained fire suppression agent. The valve assembly may be configured to contain or inhibit any fluid or pressure loss when connecting or disconnection a fire extinguisher unit to or from the fire suppression system.

According to another aspect of the disclosure, each valve assembly may be made of a suitable material, which can render the valve assembly corrosion resistant.

According to another aspect of the disclosure, when connected to the fire suppression system, if activated, the contained fire suppression agent may exit the tank of the fire extinguisher unit and will disperse from a fire suppression burst tube, nozzle, or other dispersion feature of the system and suppress a fire.

According to another aspect of the disclosure, one or more of the fire extinguisher units may be released or disconnected under pressure from the fire suppression system and may be used manually to suppress a fire. Each detached unit may be used as needed to manually and directly suppress a fire or a portion of the fire. Also, the unit may be used to suppress a fire in a non-suppressed environment at a location remote from the fire suppression system. The disconnected fire extinguisher unit may also be taken from one location to another to assist an activated fire suppression system. Once the fire extinguisher unit has been released from the fire suppression system, both the fire extinguisher unit and the fire suppression system may maintain the original starting pressure with minimal pressure or agent loss.

According to another aspect of the disclosure, the disclosed fire suppression apparatus, system, and method provide the advantage that a fire extinguisher unit can be made to quickly disconnect from the system when it is advantageous to do so. This may be accomplished, for example, by controlling the release of the male/female connector of the valve assembly and thereby controlling the release of agent from either the detached fire extinguisher unit or the pipe or tube of the fire suppression system. The fire extinguisher unit and/or fire suppression system may be ready to use within seconds or minutes after the unit is disconnected under pressure from the main fire suppression system. Such a controlled disconnection of the fire extinguisher unit from the fire suppression system ensures that, at any given moment, a backup system or in some cases a primary fire extinguisher would always be ready for use.

For example, if a fire suppression system was installed in a vehicle and the vehicle encounters an accident requiring a fire extinguisher, the trained occupant of the vehicle may easily disconnect a fire extinguisher unit and direct suppression agent to the fire. This may potentially save lives or assets. The same may apply for other circumstances and environments, such as mining equipment, aviation equipment, and the like.

According to another aspect of the disclosure, to initiate the disconnection of the male/female connector, one may move a release coupling and pull the fire extinguisher unit away from the suppression system. This may close one or more one-way valves.

According to another aspect of the disclosure, the first and second parts of the male/female connector of the valve assembly may be connected to each other with a set of one-way valves. The one-way valves may be poppet valves or the like, and may be of a pull to release type, a lift to release type, a turn to release type, a break to release type, a de-couple to release type, or the like. The presence of the one-way valves and the manual release operation help to ensure that the fire extinguisher unit is retained in position and secured as necessary while suppression agent can flow to the pipe or tube, especially when installed in a high vibration application. The presence of the one-way valves further helps to control the release of the fire extinguisher unit from the suppression system without a drop in pressure of loss of suppression agent from either the pipe or tube or the fire extinguisher unit.

According to another aspect of the disclosure, the valve assemblies may be made of a stainless-steel material, a carbon steel material, or the like. This may ensure that the valve arrangement is capable of maintaining good mechanical functionality while resisting corrosion and offering corrosion protection for the system.

According to another aspect of the disclosure, each detachable fire extinguisher unit may be adapted to move out of a first position connected to the fire suppression system only when a pin, handle, or coupling on one side of the fire extinguisher unit is removed or actuated. Thus, the movement can readily control the disconnection of the fire extinguisher unit.

According to another aspect of the disclosure, the fire extinguisher unit may be adapted to move out of the first position when a force applied by an actuator to one side of the male/female connector of a valve assembly exceeds a force threshold. This may advantageously facilitate remote actuation and controlled release by application of a physical force direct to the male/female connector. In one example, the actuator may be a remotely operated hammer or rod.

According to another aspect of the disclosure, O-ring seals may be provided between the first and second parts of the male/female connector joining a fire extinguisher unit to the fire suppression system to provide a seal therebetween.

These and other objects, features, advantages, and aspects of the disclosed fire suppression apparatus, system, and method should become apparent to those having ordinary skill in the art upon reading this disclosure.

Turning now to the drawings, FIG. 1 shows a simplified schematic of a known fire suppression system 10. The system 10 includes a reservoir, container, or tank 12 holding a fire suppression agent 14. The tank 12 is connected to a tube or pipe 16 of the fire suppression system 10. The tank 12 is connected to a wall or surface by a clamp 18 and is not removable in emergencies or for secondary use. The pipe 16 may be a series of pipe segments joined together or may be a continuous tube. The pipe 16 includes one or more dispersion nozzles 20 to disperse the agent, when the system 10 is activated. The tank 12 may include a pressure gage 22 and the pipe 16 may also include a pressure gage 24. The gages 22, 24 can detect and display or indicate the pressure within the tank 12 and within the pipe 16 of the system 10, respectively. The tank 12 can include a feed tube 26 inside the tank to direct the suppression agent 14 from the tank, to exit the tank, and to the pipe 16.

FIG. 1 shows a standard fire suppression system 10 known in today's market. The tank 12 is typically hard connected to the pipe 16 and nozzles 20 of the fire suppression system 10 by the fixed connector 17. The system 10 acts as a single use fire suppression system. It should be noted that the tank is a storage reservoir and thus does not include a fire extinguisher handle, release lever, tamper seal, pull pin, and hose of a typical fire extinguisher. Instead, the tank 12 includes a single connector 28 that allows the pipe 16 to be connected directly to the tank. The system 10 maintains pressure within the tank 12 and the pipe 16. The system 10 operates by the nozzles 20 being actuated by smoke detection and then releasing agent to suppress a fire. The fire suppressing agent may be water, foam, dry powder, CO₂, wet chemical, or the like, as is known in the art.

FIG. 2 shows a simplified schematic view of a fire suppression system 30 constructed according to the teachings of the present disclosure. The fire suppression system 30 includes at least one apparatus, i.e., a fire extinguisher unit 32 that is modified so as to be connectable to and detachable from the system. The system 30 may include two or more of the detachable fire extinguisher units, as is more clearly described below, though only one is specifically shown and described in this example. Alternatively, such a system may also include one or more non-removable storage reservoirs, such as an agent holding tank (like the tank 12 of FIG. 1). Though one fire extinguisher unit 32 is described below, the description may be considered to apply equally to any one or more additional such units of the system 30.

As shown in FIG. 2, the system 30 includes a tube or pipe, i.e., pipe 34, which may again include a series of pipe segments joined to one another at connectors or joints. The pipe may be a metal pipe, plastic tubing, or the like. The size, i.e., diameter of the pipe can vary according to the design needs of a given application. The system 30 also includes a valve arrangement with one or more valve assemblies 38. A valve assembly 38 can be provided to connect each of the fire extinguisher units 32 to the pipe 34. The fire extinguisher unit 32 in this example may be detachably connected to a wall or surface for reasons noted further below.

The pipe 34 has one or more dispersion features or elements. In one example, the dispersion features may again be in the form of a number of nozzles 40 provided along the pipe 34 to disperse the agent when the system 30 is activated. In another example, the pipe 34 may be in the form of plastic tubing with a pipe wall specifically designed to burst and disperse suppression agent at points subjected to flames or high temperatures caused by a fire. The fire extinguisher unit 32 includes a tank 42 that holds a pressurized fire suppression agent 44. The fire extinguisher unit 32 may include a pressure gage 46 and the pipe 34 may also include a pressure gage 48. The gages 46, 48 can detect and display or indicate the pressure within the tank 42 and within the pipe 34 of the system 30, respectively. The tank 42 can again include a feed tube 50 inside the tank to direct the suppression agent 44 to exit the tank.

In this example, the valve arrangement includes a first valve assembly, i.e., the valve assembly 38, coupled to the pipe assembly 34 as a part of the fire suppression system 30. The valve arrangement also includes a second valve assembly 52 provided as a part of the fire extinguisher unit 32. Each of the valve assemblies 38, 52 may be conventional in construction and may have mating flat-face, no spill couplings. Each valve assembly 38, 52 also may have a poppet style shut-off valve body. The valve assemblies 38, 52 and poppets may employ O-ring seals or metal-to-metal seating elements. Each valve assembly 38, 52 may also include a bias element or spring to assist closing the valves when the fire extinguisher unit 32 or the suppression system pipe 34 has low pressure in the system. The valve assemblies 38, 52 may be configured to withstand zero (0) to ten thousand (10,000) PSI covering low and high pressure systems. When the system 30 components are connected, the valve assemblies 38, 52 can be configured so that pressure and suppression agent 44 can be diverted from the tank 42 to the pipe 34 when the system is activated in an open condition.

The suppression system 30 can further include valves and connectors to connect additional elements together and to the system. Such elements may be optional and may include additional electronics, an emergency release, additional pressure gauges, one or more discharge ports, one or more charge ports, additional fire extinguisher units, additional storage tanks, and the like.

FIG. 2 shows the flow path of the fire suppression agent 44 from the tank 42 of the fire extinguisher unit 32 when the unit is connected to the suppression system 30 and when the system is activated upon detecting a fire. The second valve assembly 52 is closed and the first valve assembly 38 is open. The agent 44 thus may flow from the tank 42 through the valve assembly 38 and into the pipe assembly 34.

FIGS. 2 and 3 also show the differences between the known fire suppression system 10 of FIG. 1 and the fire suppression system 30 according to the teachings of the present disclosure. In this example, the apparatus, i.e., the fire extinguisher unit 32 and valve assembly 38, includes a feature allowing connection to and detachment from the fire suppression system 30. The feature includes a male/female connector 60 positioned between the fire extinguisher unit 32 and the pipe 34, and thus between the two valve assemblies 38, 52. The male/female connector 60 is a valve disconnection/connection device that joins the fire extinguisher unit 32 to the pipe 34 of the fire suppression system 30. The connector 60 has a first part 62 that is carried on the fire extinguisher unit 32 and a second part 64 that is carried on the pipe 34. When the first part 62 on the fire extinguisher unit 32 is connected to the second part 64 on the pipe assembly 34, the connector 60 is in an open flow condition permitting the tank 42 to fluidly communicate with the pipe 34 and thus transfer the agent 44 therebetween. Other differences lie in the fire extinguisher unit 32, which replaces the tank 12 of the known system in FIG. 1. The fire extinguisher unit 32 may include an extinguisher handle 66, a release lever 68, a tamper seal (not shown), a pull pin (not shown), and a hose 70.

The connector 60, when in the connected condition, diverts the agent 44 from the tank 42 of the fire extinguisher unit 32 to the suppression pipe 34 and thus to the dispersion features, such as the nozzles 40. This charges, i.e., pressurizes the fire suppression system 30, making it ready for activation. The readiness of the system 30 can be noted by checking the pressure via the one or more gauges 46, 48 that are installed within the system. The valve assembly 38 that is connected to the pipe 34 of the fire suppression system 30 has one or more ports 72. These ports 72 allow the system 30 to be energized with the agent 44, which can be a fluid, a powder, a gas, or a combination of such agents. The ports 72 of the valve assembly 38 also permit the system 30 to thus be charged and discharged and to distribute the agent through the system. The ports 72 further allow the valve assembly 38 and the fire extinguisher unit 32 to be interlinked and connected together with other elements of the system 30, such as one or more additional fire extinguisher units and valve assemblies, and/or with one or more additional fire suppression systems. The ports 72 also may connect to pressure and temperature switches, emergency activation switches, and/or emergency shut down (ESD) switches.

FIG. 3 shows a close up of a portion of the fire extinguisher unit 32 of FIG. 2. The connector 60 includes the first and second parts 62, 64, i.e., the male/female connector parts in this example. The first and second parts 62, 64 may be or include male and female parts that each carry a poppet valve that opens flow through the connector 60 when the fire extinguisher unit 32 is connected to the valve assembly 38 of the system 30. In the open position as shown, the agent 44 is allowed to flow from the tank 42 of the fire extinguisher unit 32 into the valve assembly 38, which directs and distributes the agent 44 into one or more suppression pipes 34 or other parts of the system 30.

As shown in FIG. 3, the connector 60 may include a coupling 74 that can lock the connector in the connected condition. At this stage, pressure and thus agent 44 can be transmitted from the fire extinguisher unit 32 to the pipe 34 of the fire suppression system 30. The agent 44, however, is not released into the atmosphere until a fire has been detected or the fire extinguisher unit 32 has been disconnected from the valve assembly 38 and used manually, as discussed below.

In the disclosed example, the fire suppression system 30 has a minimum of one (1) valve assembly 38 with one (1) connector 60 per system and at least one detachable fire extinguisher unit 32. The connector 60 also has at least two (2) one-way valves, one to close each part of the connector when disconnected. The disclosed connector and valve assembly are not limited herein to any specific design, configuration, valve type, connection type, or the like. The valves may be within the connector 60, within a body 76 of the valve assembly 38, or elsewhere, as long as they open when the unit 32 is connected to the system 30 and closed when the unit is detached. The connector 60 and one-way valves may be in a horizontal orientation adjacent the fire extinguisher unit 32 or may be vertically mounted above the fire extinguisher handle 66. The one-way valves open when the first and second parts 62, 64 of the connector 60 are connected and close and seal when disconnected. The body 76 may be termed a valve body, suppression block, or the like and may include a minimum of one port 72 that is separate from the connector flow path into the body. The port 72 can function as both an inlet port and an outlet port for flow of the agent 44 and for pressurization or charging of the system 30 with the agent. The valve body 76 may have additional ports 72 connected to additional parts or pipe sections of the system 30. Unused ports 72 may be closed off or plugged by suitable plugs P or other such devices. The valve body 76 may also be configured to include additional ports or connectors for connection of electrical components, emergency switches, pressure gauges, a bleed port, and the like.

FIG. 4 shows the fire extinguisher unit 32 disconnected from the fire suppression system 30. When disconnected, the first and second parts 62, 64 of the connector 60 are disconnected from one another. In one example, the coupling 74 may be a threaded lock coupling that is rotated in one direction to release the connection and in the other direction to secure the connection of the connector 60. Disconnecting the connector 60 and releasing the first part 62 from the second part 64 closes the valve assembly 38, including the two one-way valves on the corresponding first and second parts. When closed and sealed, isolated system pressure is maintained in each of the parts 62, 64. Thus, the fire extinguisher unit 32 and the pipe 34 of the system are isolated from one another, blocking the pressure/flow of agent between the suppression system 30 and the detached fire extinguisher. This allows the fire extinguisher unit 32 to be removed and used manually.

The pipe 34 may be a smaller diameter plastic tube, such as a 3 mm to 5 mm inside diameter (ID) tube. With a smaller diameter tube size, the pipe 34 may not be functional as a suppression system 30, i.e., may not retain sufficient volume and pressure, to adequately suppress a fire with the fire extinguisher unit 32 detached. In other examples, the pipe 34 may be a larger diameter plastic tube, such as a 15 mm ID tube. With a larger diameter tube size, the pipe 34 may be functional as a suppression system 30, i.e., may retain sufficient volume and pressure, to adequately suppress a fire with the fire extinguisher unit detached.

In order to use the fire extinguisher unit 32 manually, a user should detach the unit and free up the release lever 68 and handle 66, such as by removing a lock pin or pull pin (not shown). Once ready, the user can detach the unit from the valve assembly 38 and manipulate the release lever 68 and handle 66 to open the valve assembly 52 on the fire extinguisher unit 32 to divert the agent 44 from the tank 42 to the hose 70. If the fire extinguisher unit 32 has not been activated and the agent not dispersed, the fire extinguisher unit may be reconnected to the valve assembly 38 of the fire suppression system 30. The fire extinguisher unit 32 can then be checked and made ready for use with the fire suppression system 30. If the fire extinguisher unit 32 has been used and the agent 44 discharged, the unit should be replaced or recharged and then can be reconnected to the system 30. If desired, the system 30 may be recharged through another port, remote from the fire extinguisher unit 32 or the valve assembly 38, once the unit is reconnected to the system. With the fire extinguisher unit 32 detached and ready for manual use, the remaining portions of the fire suppression system 30 may be deactivated.

FIG. 5 shows an alternative example of a lock and release feature for the fire extinguisher unit 32, which may replace or supplement the above mentioned coupling 74. In this example, the fire extinguisher unit 32 may be fitted with a handle release mechanism 80. The handle release mechanism 80 may act as a locking device that, when attached to the fire extinguisher unit 32, secures the two one-way valves of the valve assembly 38 or connector 60 in the open position and secures the unit to the fire suppression system 30. When required or desired, the handle release mechanism 80 may be pulled, pushed, or otherwise actuated to release the fire extinguisher unit 32 from the suppression system 30. This action should also close the two one-way valves of the respective first and second parts 62, 64 of the connector 60 to isolate them from each other and allow the fire extinguisher unit to be detached and used manually. The handle release mechanism 80 may be useful in low vibration environments and used to compress the two one-way valves open until the mechanism is released.

FIG. 6 shows another simplified schematic of another example of a fire suppression system 90 constructed in accordance with the teachings of the present disclosure. The system 90 merely includes multiple elements described above for a more complex system. In this example, the pipe 34 includes a plurality of pipe segments 34a joint to one another at joints or connectors 36. These joints or connectors 36 are configured to permit flow of agent 44 along the various pipe segments 34a of the system 90. The joints or connectors 36 may also include additional ports for interconnecting further system elements, such as additional pipe segments 34, gauges, switches, ESD switches, a controller, a control panel, and the like.

In this example, the fire suppression system 90 includes two of the detachable fire extinguisher units 32. Each unit 32 can be separately detachable from the system 90 via a respective valve assembly 38 and used to suppress a fire. With one or both units 32 detached, the system 90 may still function to be capable of fire suppression. For example, the fire suppression system 90 also in this example includes two permanent or fixed agent storage tanks 12. These tanks 12 can be utilized to store additional suppression agent 44 and to aid in charging or pressurizing the system 90. The fire suppression system 90 also includes multiple dispersion features, such as nozzles 40, distributed along the pipe 34. These dispersion features may again vary and, for example, may be formed by the pipe 34 locally bursting when subjected to flames or high temperatures caused by a fire, as described above. Further, the system 90 in this example is shown as a closed system, with the pipe segments 34a joined to form a continuous agent flow circuit. Instead, the system may be configured similar to the systems 10 and 30, with a discontinuous flow path. Terminal ends of the pipe 34 may then be capped or plugged, as desired. A gauge (not shown) may be placed at each end of the open ended circuit to both close off the ends as well as to provide the pressure indication function.

The foregoing describes a fire suppression apparatus and system. The apparatus and system may be readied for use, as represented in FIG. 7. The disclosed fire suppression apparatus and system may also be used to suppress a fire when activated, either with the system completely installed and assembled, or with the fire extinguisher unit 32 detached. FIG. 7 shows one example of a method flow chart for readying a fire suppression system. Other examples may include more steps or fewer steps than those steps depicted in FIG. 7, and may also include fire suppression steps, which are not represented in FIG. 7. In one example, a method may include designing and/or selecting a fire suppression system according to the needs of a particular environment (S100). The appropriate system is then installed in the environment (S102). Once installed, the system is charged with an appropriate fire suppression agent (S104). The charging may be done by connecting one or more of the fire extinguisher units 32 to the system or may be done via one of the pipe segments 34a or the pipe 34 of the system, remote from the one or more units 32. Once charged, numerous qualities or characteristics of the system can be checked. For example, the system charge pressure can be checked by noting the pressure at the gauge or gauges (S106). As another example, the one or more fire extinguisher units 32 can be disconnected to test the capability and function of the disconnect (S108). Also, the system can be checked for leaks (S110).

After the system checks are completed, the one or more fire extinguisher units 32 can be reconnected to the system (S112). The system pressure can again be checked, such as by noting the reading of the gauge or gauges (S114). The system can also again be checked for leaks (S116). The system may then be determined as ready for use (S118).

During use, the system may be activated manually to begin fire suppression. Alternatively, the system may be activated automatically. The dispersion features may be configured to automatically discharge agent upon detecting smoke, detecting fire or flames, or detecting a certain temperature threshold. Alternatively, the system may be connected to a controller or control board that is programmed to make the determination of activating the system. The components of that controller or control board may include one or more processor, sensors, and the like.

The disclosed fire suppression system 30 may also include other features and components. For example, the valve body of each valve assembly may be provided with multiple ports. Unused ports may be blocked off on an installed system, such as with the aforementioned plugs P. Each of the ports may be used for one or more functions, including delivery of the fire suppression agent, charging of the system, discharging of the system, connection to a pressure gauge, connection of additional pipe segments, emergency shut down, connection to a control panel, and/or the like. The control panel can be added and utilized to control and monitor various system parameters and functions. The control panel can be configured and operated to control charging and discharging, monitor pressure, shut down and activate the system, conduct an emergency shut down, detect leaks, detect improper valve operation and fire extinguisher unit connection, and the like.

The fire extinguisher unit or units 32 may be disconnected from the fire suppression system 30 in a variety of ways. In one example, the unit may be lifted away from the valve assembly 38 when the unit is released from a mounted carrier (not shown). In another example, the unit may include an electronic release coupled to a controller, control unit, control panel, or the like. The electronic release may allow the one-way valves of the connector 60 to be closed with an emergency release or ESD button, closing both valves and sealing the system before the fire extinguisher unit is removed by hand. This type of system may also be connected to machinery and may shut down mechanical or electronic systems when the fire suppression system is activated, or when the fire extinguisher unit is released.

In another example, the connector 60 may include only a single one-way valve on the first part 62. When the fire extinguisher unit is detached or disconnected, the one-way valve will isolate the unit to maintain the agent and pressure in the tank 42 so that the unit may be used manually to suppress fire. However, in this example, the pipe 34 of the suppression unit would then leak agent and/or lose pressure and would not be available for use to suppress fire. Such a system might be used for lower cost applications or small tight spaces where a single use fire suppression activation might be expected. Such a system might also be used for smaller ID pipe where the system might not be capable of maintaining sufficient volume or fluid pressure to suppress fire anyway, once the fire extinguisher unit is detached.

In another example, the fire extinguisher unit may include a safety, i.e., pull or push pin that must be removed before the unit can be released. The unit may include a push-to-release or pull-to-release mechanism or feature. A handle or lever, which in emergencies releases the unit from the suppression system when pushed or pulled may allow the safety pin to be removed before the fires extinguisher unit is released. In another example, the valve assembly may be vertically mounted with the valve arrangement. The valve assembly may permit a twisting or rotating movement, either left or right, allowing the fire extinguisher unit to drop and release from the fire suppression system. In another example, the valve assembly may permit the fire extinguisher unit to be turned or rotated to unscrew the unit from the valve assembly. In another example, the fire extinguisher unit may require a combination of push, pull, and release of a safety pin or a break bar to remove the unit. In another example, the fire extinguisher unit may again include an electronic release as noted above but may also have a built in or programmed memory and sensors linked to ESD functions that are built into the fire suppression system or the environment in which the system in installed.

As noted previously, the disclosed fire suppression systems may be used for a range of applications in a wide variety of environments. Some examples include: vehicle engine bays; vehicle crew cabs; server rooms; industrial machines; aviation environments; on board airplanes and helicopters; mining environments and equipment; other transportation environments and equipment; motorsport vehicles, garages, and the like; kitchens; buildings; petrochemical facilities; fuel trucks; paper plants; airports and depots; conveyor systems; document rooms; boat, ships, cruise liners, and the like; hospitals; hotels; private homes; gas stations; military vehicles, equipment, and environments; offshore installations; wind turbines; and the like.

The disclosed fire suppression systems can be used and charged quickly and easily with minimal downtime. The disclosed fire suppression systems are easy to assemble, install, and maintain. Use of flexible plastic tubing as the pipe allows for fitting the system into tight spaces and within and around complex shaped areas, machines, and the like. The disclosed fire suppression systems are also easy to activate and use, whether automatically or manually, as an installed, connected unit, or manually with one or more fire extinguisher units detached. The fire suppressing agent can be liquid, gas, powder, or a mixture of any such agents, depending on the location and hazards within the area. The chosen agent may be suitable for a given environment so as not to require significant clean up, if activated, and so as not to damage the environment and articles and equipment in that environment. The fire suppressing agent may be water, foam, dry powder, CO₂, wet chemical, or the like, as is known in the art.

The disclosed dispersion elements may vary as well. Conventional nozzles are described above as one option for the fire suppression system. However, other types of dispersion elements or features may be utilized instead. In one example, the dispersion elements may be localized bursts of the pipe or tubing. Such a burst may be caused by localized heat from a fire elevating the temperature at a point or location along the pipe in combination with the relatively high internal pressure within the system. If the temperature reaches a certain threshold, the pipe at that point or location may be configured to burst, allowing the pressurized agent to escape and suppress fire within reach of the burst region of the pipe. In one example, the entire wall of the pipe may be capable of bursting, if subjected to localized heat, thus permitting a burst at any position along the pipe. In other examples, burst points, such as thinner walled or weakened points, may be provided along the pipe, each configured to burst or capable of bursting.

Although certain fire suppression apparatuses, systems, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A fire suppression system comprising:
a pipe having one or more dispersion features;
a valve assembly coupled to the pipe; and
a fire extinguisher unit coupled to the pipe via the valve assembly, the fire extinguisher unit including a tank containing a fire suppressing agent,
wherein the valve assembly includes a connector with a first part attached to the fire extinguisher unit and a second part attached to the pipe,
wherein the valve assembly is configured to permit the fire extinguisher unit to be connected to the pipe of the fire suppression system to share the fire suppressing agent with the pipe and the one or more dispersion features to suppress fire or to be disconnected from the pipe for manual use to suppress fire.

2. The fire suppression system of claim 1, wherein the valve assembly is configured to contain any fluid or pressure loss in the fire extinguisher unit and the pipe when the first part and second part of the valve assembly are disconnected when the fire extinguisher unit is disconnected from the pipe.

3. The fire suppression system of claim 1, wherein the valve assembly is corrosion resistant.

4. The fire suppression system of claim 1, wherein, when activated, the fire extinguisher unit is configured so that the suppressing agent exits the tank and can be dispersed from the one or more dispersion features of the pipe to suppress fire.

5. The fire suppression system of claim 1, further comprising two or more of the fire extinguisher units and respective valve assemblies, each of the two or more fire extinguisher units being releasable under pressure from the pipe and usable manually to suppress a fire.

6. The fire suppression system of claim 1, wherein a one-way valve is provided at least the first part of the connector, and wherein the one-way valve is closed to isolate the fire extinguisher unit for use in manually suppressing fire when the connector is disconnected to release the fire extinguisher unit.

7. The fire suppression system of claim 1, further comprising a coupling associated with the connector of the valve assembly, wherein the coupling is actuatable to release the fire extinguisher unit from the pipe.

8. The fire suppression system of claim 7, wherein a one-way valve is provided on each of the first part and the second part of the connector, and wherein each one-way valve is closed and isolated from the other when the coupling is actuated to release the fire extinguisher unit.

9. The fire suppression system of claim 1, wherein the first part and the second part of the connector of the valve assembly are connected to each other with a set of one-way valves.

10. The fire suppression system of claim 1, wherein the valve assembly is made substantially from a stainless-steel material or a carbon steel material.

11. The fire suppression system of claim 1, wherein the one or more dispersion features are nozzles attached to the pipe.

12. The fire suppression system of claim 1, wherein the pipe is configured to locally burst when subjected to a fire, and wherein each burst in the pipe defines one of the one or more dispersion features.

13. An apparatus for a fire suppression system, the apparatus comprising:
a fire extinguisher unit including a tank containing a fire suppressing agent, a manual valve assembly, and a hose in fluid communication with the tank via the manual valve and operable for dispersing the fire suppressing agent; and
a valve assembly coupled to the tank, the valve assembly having a connector with a first part attached to the fire extinguisher unit and a second part attached to a valve body configured to be attached to a pipe of a fire suppression system,
wherein the valve assembly is configured to permit the first part and the second part of the connector to be connected in order to share the fire suppressing agent with the pipe and the fire suppression system, and to permit the first part to be disconnected from the second part of the connector in order to permit manual use of the fire extinguisher unit to suppress fire.

14. A fire suppression system comprising:
a pipe with one or more dispersion features;
a valve assembly coupled to the pipe; and
a fire extinguisher unit coupled to the pipe via the valve assembly,
wherein the valve assembly is configured to permit the fire extinguisher unit to be connected to the pipe to share the fire suppressing agent with the pipe and the one or more dispersion features to suppress fire and to permit the fire extinguisher unit to be disconnected from the pipe for manual use to suppress fire.
